(19) United States
(12) Patent Application Publication
(10) Pub. No.: US 2003/0066593 A1
(43) Pub. Date: Apr. 10, 2003

(54) Elastic band

(76) Inventor: Alberto Kopelowicz, Capital Federal (AR)

Correspondence Address: Robert E. Bushnell, Suite 300, 1522 K Street, N.W., Washington, DC, 20005, US

(21) Appl. No.: 10/244,646

(22) Filed: Sep. 17, 2002

(30) Foreign Application Priority Data
Oct. 5, 2001 (AR) P010104712
Mar. 7, 2002 (AR) P020100842

(51) Int. Cl. B32B 31/00; B32B 31/20

(52) U.S. Cl. 156/229; 156/164; 156/163; 156/308.2; 156/494

(57) ABSTRACT

A method of securing an elastic band having an elastic and a meltable material film to an article includes the steps of extending the article on a workbench, positioning the elastic band on the article, activating the meltable material layer, pressing the elastic band on the article, and cutting the article along with an edge of the elastic band. The method preferably further includes the step of heat-pressing the secured elastic band. An apparatus for performing the method includes an axis, a roller mounted on the axis, a cutter having a blade, and a pipe supplying a hot air toward an area of the article on which the elastic band is positioned. The roller and the cutter are freely rotational with respect to the axis. When the article is in contact with the roller, a movement of the appratus or the article makes the roller and the cutter rotate. With this configuration, it is possible to more efficiently secure the elastic band to the article, and the cutting and the securing are performed simultaneously.

### CLAIM OF PRIORITY

This application makes reference to, incorporates the same herein, and claims all benefits accruing under 35 U.S.C. §119 from an application for ELASTIC BAND earlier filed in the Argentine Patent Office on Oct. 5, 2001, and there duly assigned Serial No. P010104712 by that Office and an application for ELASTIC BAND earlier filed in the Argentine Patent Office on Mar. 7, 2002 and there duly assigned Serial No. P020100842 by that Office.

### BACKGROUND OF THE INVENTION

1. Field of the Invention

The present invention relates to an elastic band, more particularly, to an elastic band for an application on articles used for manufacturing garments, and a method and an apparatus for securing the elastic band to the articles.

2. Description of the Prior Art

The conventional way of providing a garment with elasticated edges is to sew an elastic band to an edge of the garment. This conventional method requires the steps of folding an edge portion of the garment where the elastic band will be positioned, and applying enough sewing lines to secure the elastic band steadily and effectively, as well as to ensure an edge termination that does not create undesired fraying. Particular problems in this conventional way are that the elastic edge portion is thicker than the rest of the garment and, furthermore, it is highly visible. In the case of a brassiere, there are more than twenty steps or sewing lines that are incorporated for securing the elastic bands.

In order to solve the above problems, the prior art attempts to eliminate the presence of the mentioned thicker edge portions by designing garments to keep a thickness constant throughout the garment. For instance, where a brassiere is comprised of two overlapping elastic pieces which are premolded and bonded together by heat, there is no need to include the elastic band. Consequently, there is no need to sew to secure the elastic band to the garment. Sewing is thus only used for securing straps and clasps. These garments are also known as “monopiece” due to the fact that, with exception of straps, they consist of a unique piece molded by applying pressure and heat. One problem associated with these garments is that an entirely new technique for manufacturing those garments is required. In manufacturing those garments, the manufacturing process is artisanal, rather than be machine-made. It makes the garments very expensive and limited. Another problem is that two overlapping materials impede the garment's ventilation so that the wearer feels uncomfortable. Another problem is also that those garments become less effective with time, lose their original shapes and fail to satisfy wearers. Furthermore, this method is limited in that it applies only to the garments made of elastic materials. That is, this method cannot be used for inelastic textiles. Moreover, in many cases, it is still preferable that the elastic adjustment is done at the edge lines, especially when the garment such as brassieres also serves a purpose of providing support.

A more efficient technique for attaching an elastic band is the use of a heat-activated coating on the elastic or a separate adhesive. In this case, an apparatus and a method for a high production are still required. The prior art does not disclose an apparatus and a method for securing the elastic band for a high-production, without excessively heating the remaining portions of the garment and without a plurality of serially arranged machines.

### SUMMARY OF THE INVENTION

It is therefore an object of the present invention to provide an improved method and apparatus for securing the elastic band to an edge of the article, particularly, the article to be used in manufacturing garments.

It is another object to provide an apparatus and method well suited to modem, high-production processes.

It is also an object to provide an improved apparatus which is able to perform a step of positioning, adhering, and cutting.

It is further an object to provide an edge of an article on which an elastic band is secured with a definitive edge termination to prevent the edge from fraying.

It is still further an object to provide an improved method and apparatus for providing an article with an elastic band without excessively heating the nonedge portions of the garment and without a plurality of serially arranged machines.

It is yet further an object to provide an improved method and apparatus for providing an article with an elastic band regardless of the shape of the article.

In order to achieve the above and other objectives, the preferred embodiments of the present invention include the elastic band constructed with an elastic and a meltable material film. The elastic is comprised of elastic threads which are parallel to one another in a longitudinal way. The meltable material film is affixed on at least one side of the flat faces of the threads so that the threads are secured by the meltable material film. This meltable material film can be affixed by heat fusion on an edge of an article to be used for manufacturing a garment. Alternatively, the elastic can be comprised of a warp and weft. It is preferred that the warp is elastic and the weft is inelastic. The preferred meltable material is thermoplastic. The most preferred thermoplastic is polyurethane.

A method for securing the elastic band to the edge of the article is comprised of the steps of extending the article on a work bench, positioning the elastic band on the article, pressing the elastic band on the article, activating the thermoplastic surface of the elastic band when the elastic band is positioned and pressed on the article, and cutting the article along with the edge of the elastic band. The method preferably further includes the step of heat-pressing the secured elastic band.

It is a highly efficient method due to the fact that it secures the elastic band on the edge of an article in a simple and highly steady manner, providing a smooth and finished blunt edge, without the presence of undesired fraying. According to this method, it is possible to ensure the positioning of the elastic band regardless of the shape of the article to be placed. It is also possible to develop automation of the elastic band collocation step and lower the garment's manufacturing costs.

The method is preferably performed by an apparatus which includes an axis mounted on a positioning device, a roller which is mounted on the axis and freely rotational with respect to the axis, a cutter having a blade which is freely rotational with respect to the axis, and a pipe supplying a hot air toward a point where the elastic band is positioned on the article. The elastic band is feed on the roller from an elastic band dispenser. It is preferred that a guide is provided for guiding the elastic band on the roller.

It is preferred that the apparatus further includes a pressing drum. The pressing drum is coaxially connected to the roller and has a longitudinal hole in which an expansion spring is mounted and connected to the axis so that the spring keeps a tendency to exert a cross sectional pressure on the article.

The cutter can be further comprised of electric means for irradiating heat on the blade. The cutter can be also further comprised of a laser source or a hot air jet.

The aforementioned steps are highly advantageous for the mentioned purpose as they enable the elastic band to be steadily positioned and the step of positioning, the step of adhering, and the step of cutting are performed simultaneously.

Furthermore, the simultaneous cutting ensures that the elastic band will bond with the edge of the article without any undesired fraying.

Once the elastic band is duly positioned, it is preferred to transfer the elastic band to a heat press for a definitive fixation of the band.

### BRIEF DESCRIPTION OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1 is a schematic plane view of an interior face of underwear.

FIG. 2 illustrates an elastic band.

FIG. 3 is a cross sectional view taken along section line III-III in FIG. 2.

FIG. 4 illustrates another elastic band.

FIG. 5 is a cross sectional view taken along section line V-V in FIG. 4.

FIG. 6 is a cross sectional view that shows an elastic band having two layers on both of the flat sides of the elastic band.

FIG. 7 is a perspective view that shows an apparatus for attaching an elastic band to an article.

FIG. 8 is a vertical sectional view of FIG. 7,

FIG. 9 is a perspective view that shows an apparatus and a new constituted edge on the article after the securing step has been completed.

FIG. 10 shows a heat press for securing the elastic band to the edges of an article.

### DESCRIPTION OF THE PREFERRED EMBODIMENT

A preferred embodiment of the present invention will be described in greater detail with reference to the accompanied drawings.

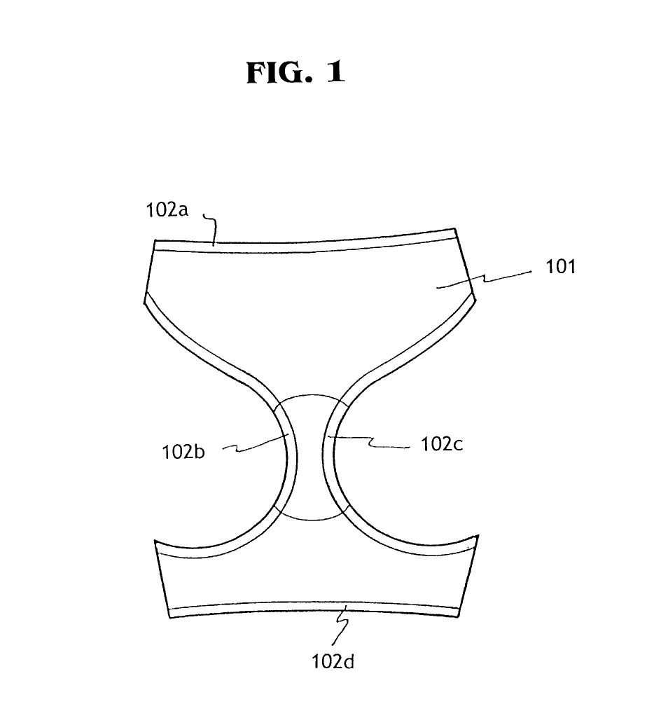

As shown in FIG. 1, elastic bands 102a, 102b, 102c, and 102d are applied on edges of an underwear 101. In the underwear 101, these edge portions must possess elasticity in order to provide the underwear 101 with an elastic adjustment. The elastic bands 102a and 102d are to provide the elastic adjustment to the wearer's waist, while the elastic bands 102b and 102c are to provide the elastic adjustment to the wearer's crotch part.

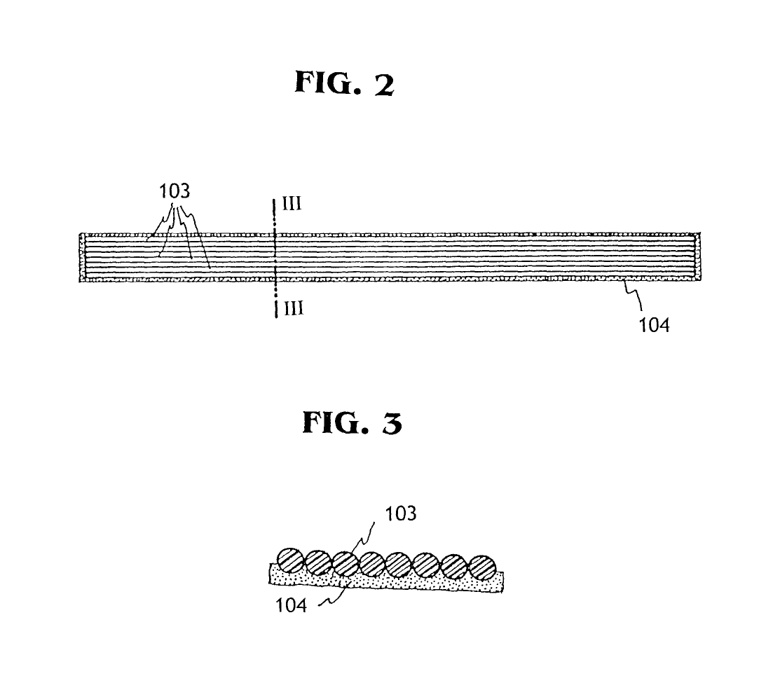

FIG. 2 shows the elastic band which comprises a plurality of lined elastomeric threads 103 and a meltable material layer 104 on which the lined elastomeric threads 103 are positioned. The lined elastomeric threads 103 are positioned in a longitudinal way and parallel to one another. The meltable material layer 104 in the elastic band makes it possible to secure the elastic band to an article, such as a textile to be used in manufacturing garments by a heat fusion process. The meltable material includes materials which are activated by a heat or pressure so that they make the elastic band secured to the article. The preferred meltable material is thermoplastic, and the most preferred thermoplastic material is polyurethane.

The section shown in FIG. 3 shows that the meltable material layer or film 104, through the heat-fusion process, maintains the lined elastomeric threads 103 duly aligned and parallel to one another.

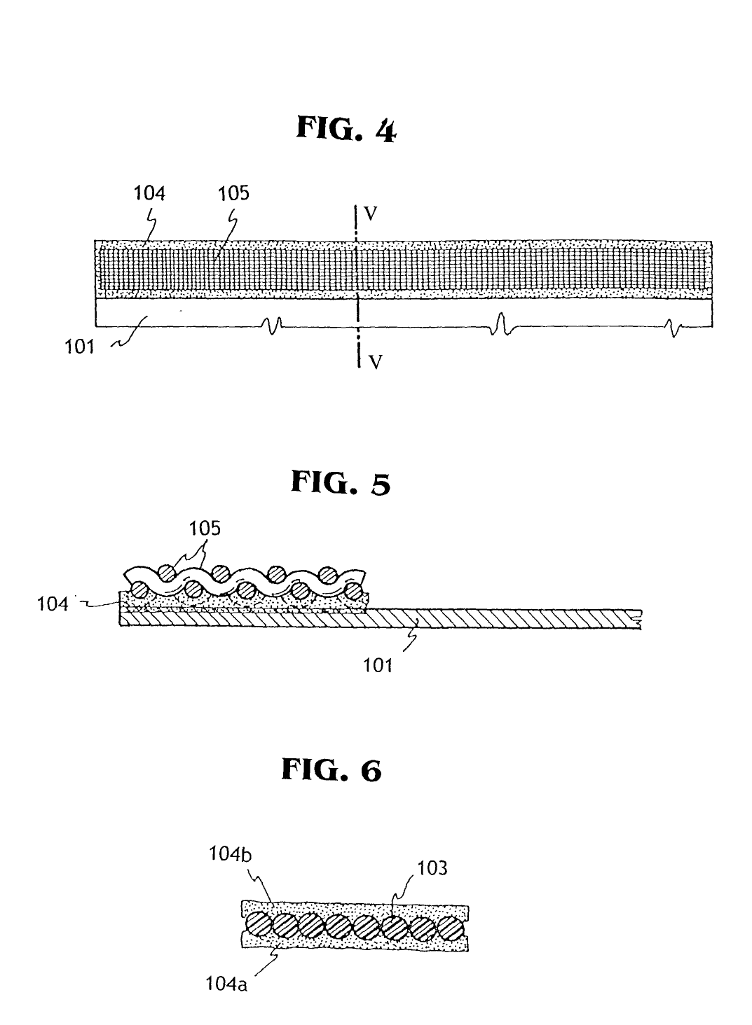

FIG. 4 illustrates the elastic band which comprises an elastic fabric ribbon 105 and the meltable material layer 104 on which the elastic fabric ribbon 105 is disposed. The elastic fabric ribbon 105 is comprised of a warp and a weft. It is preferred that a warp is elastic and a weft is inelastic.

The section shown in FIG. 5 depicts a bonding between the elastic band and the edge of the article on which it is applied. The bonding created is a close, stable and completely terminated one.

FIG. 6 shows that both faces of the elastic band are coated with the thermoplastic films 104a and 104b. In some cases, it is necessary to fix garments to both sides of the elastic band for better looking or facilitating the task of manufacturing the garment in the factory.

According to the present invention, these elastic bands are bonded by heat fusion on the piece of textile itself, which means that no sewing is required.

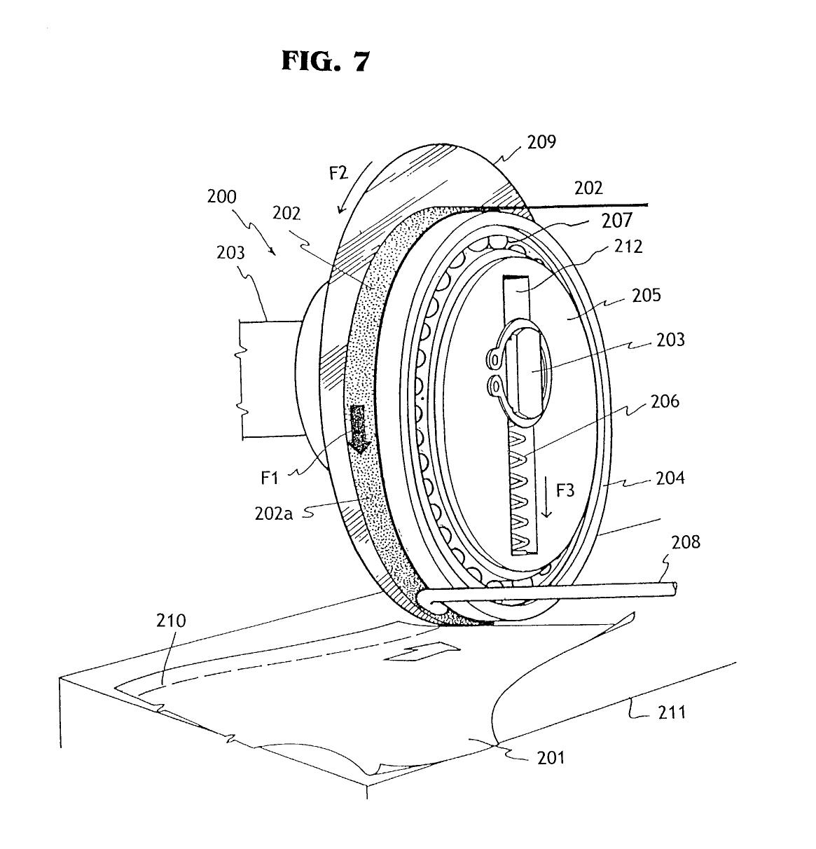

With the FIGS. 7 to 10, the procedure for securing the elastic band to the article according to the present invention will be described herein below.

Each article to be used in the confection of a garment is separately taken. The article is extended on a hard surface workbench. FIG. 7 illustrates a workbench 211 on which an article 201 has been placed. The workbench may be an external surface of a belt conveyor along which the article moves forward while facing a positioning device 200, or a fixed surface on which the positioning device 200 moves for positioning the elastic band 202 on the article 201. It is preferred that the hard surface workbench 211 is made of metallic.

The positioning device 200 is provided with an axis 203. It is preferred that the axis 203 is non-rotational.

A roller 204 is provided for receiving and positioning the elastic band 202. The roller 204 is mounted on the axis 203, and freely rotational with respect to the axis 203 as indicated by arrow, is F1. Thus, the movement of the positioning device 200 or the movement of the article 201 when the roller 204 is in contact with the article 201 translates to a rotation of the roller 204. With the rotation of the roller 204, the elastic band 202 is gradually unwrapped from a dispensing means (not shown) of the elastic band 202, and is positioned on the article 201 along the dotted line 210. When the roller 204 receives the elastic band 202, the thermoplastic layer 202a should face outwardly so that the thermoplastic layer 202a makes contact with the article 201.

It is preferred that a guide (not shown) is provided for guiding the elastic band 202 on the proper position of the roller 204.

A drum 205 is preferably mounted on the axis 203. A longitudinal hole 212 is provided in the drum 205. The axis 203 is inserted in the longitudinal hole 212 so that the axis 203 moves along the longitudinal hole 212. An expansion spring 206 is mounted in the longitudinal hole and linked to the axis 203. By pressing the expansion spring 206, the expansion spring 205 exerts a cross sectional flattening pressure toward the workbench 211. Consequently, the drum 205 keeps a tendency to exert a pressure toward the article 201, as indicated by arrow F3, when the elastic band 202 is positioned on the article 201. This pressure helps the thermoplastic layer 202a of the elastic band 202 and the article 201 more easily adhere to each other.

As shown in FIG. 7, bearings 207 are further provided between the roller 208 and the drum 205 for freely rotating the roller 24.

The thermoplastic film 202a is heated by a heater when the elastic band 202 is positioned on the article 201. As the heater, FIG. 7 shows a supply pipe 208 linked to the positioning device 200 for supplying a hot air stream. The hot air stream is sprayed on the elastic band 202 to activate the thermoplastic film 202a when the elastic band 202 is positioned on the article 201 and suffers the flattening pressure. Thus, the thermoplastic film 202a is bonded to the article 201 by heat and pressure. It is possible to spraying the hot air stream on the elastic band 202 right before or after the elastic band 202 is positioned on the article 201 by controlling the location of the supply pipe 208.

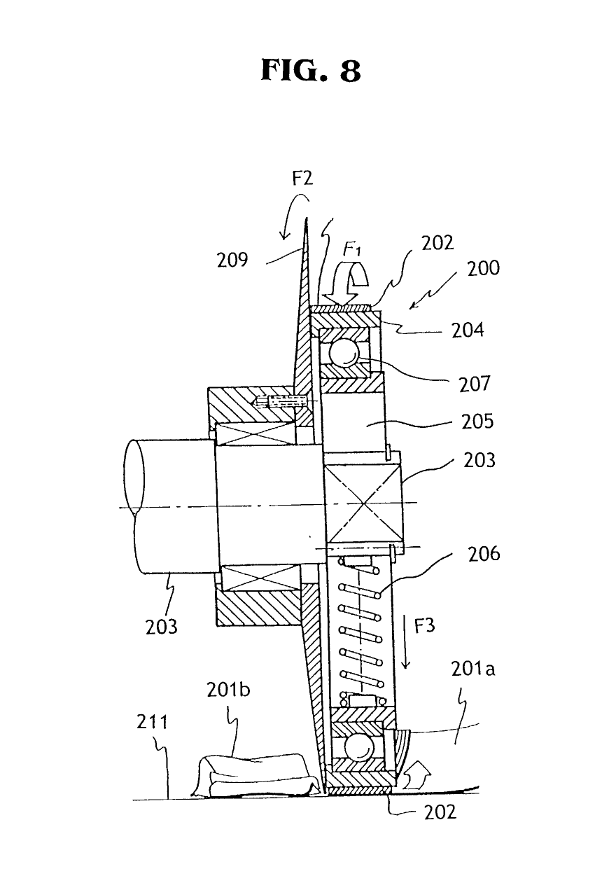

A cutter is further mounted on the positioning device 200. The cutter includes a blade 209. The blade 209 is preferably mounted on the axis 203 in such a way that a lateral edge of the elastic band 202 makes contact with a surface of a blade 209. The blade 209 is freely rotational with respect to the axis 203. Thus, the blade 209 rotates simultaneously with the movement of the device 200 or the movement of the article 201 when the blade 209 is in contact with the article 201. The rotational direction of the blade 209 is indicated by arrow F2 in FIGS. 7 and 8. The article 201 is cut along the edge of the elastic band 202 positioned on the article 201 simultaneously with the rotation of the blade 209. Consequently, the article 201 is cut into two pieces 201 a and 201b. One piece 201 a has a newly constituted edge which includes the elastic band 202. The other portion 201b of the article 201 does not include the elastic band 202 and can be discarded or reused. Since the edge of the article 201 is provided with the thermoplastic film 202a, the article has a smooth and finished blunt edge without the presence of undesired fraying.

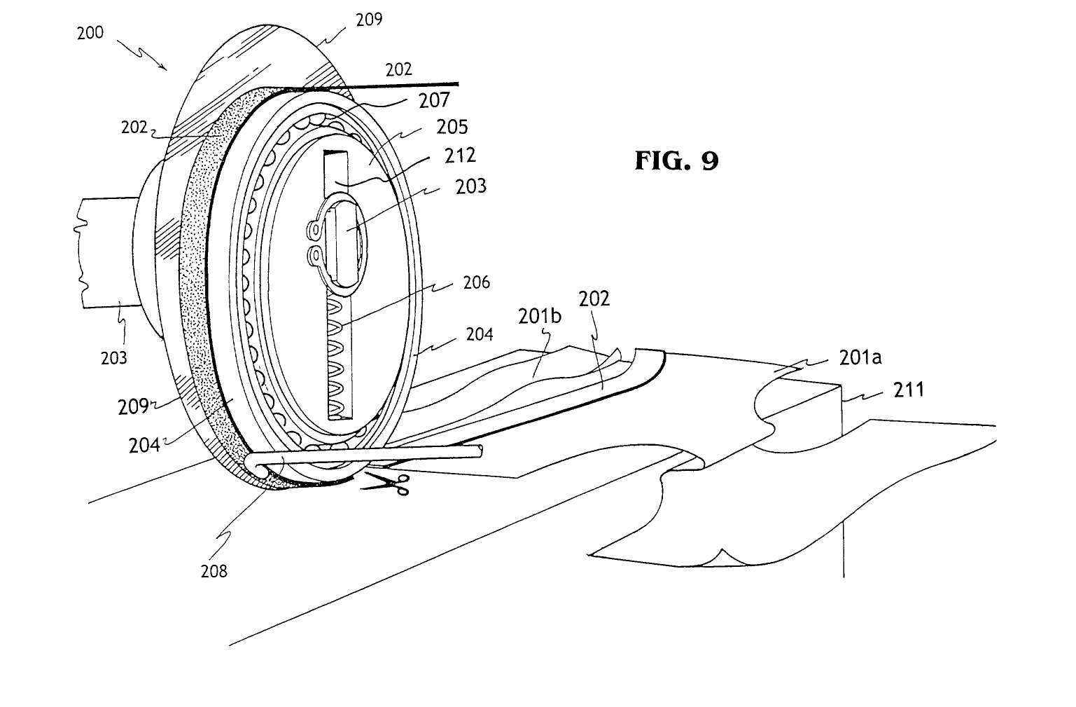

The cutter can be further provided by a heater (not shown). For instance, where the cutter has an electric resistance, a heat radiates on the cutting edge of the blade 209 so that the cutting is made when the heated blade is in contact with the article 201. Equivalent results can be obtained by using a laser ray or a high temperature air jet directed to the external edge of the blade 209. The new constituted edge on the article 201 having the elastic band 202 is also shown in FIG. 9.

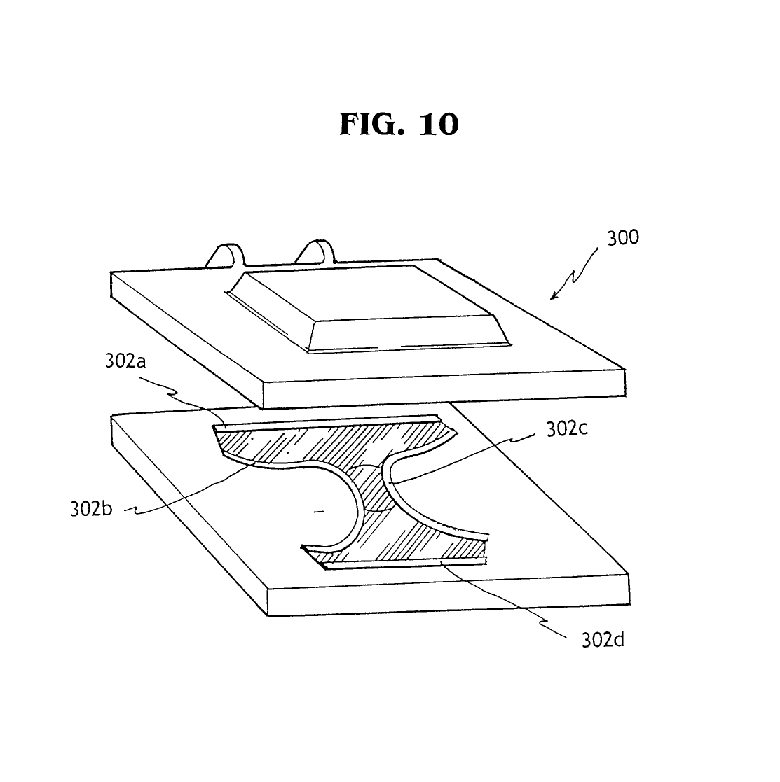

In case that the securing is not completed, it is preferred that the edge having the elastic band is further treated by heat and pressure for a stronger bonding between the elastic band 202 and the article 201. FIG. 10 shows a heat press 300 for applying pressure and heat to the edges 302a, 302b, 302c, 302d having the elastic band.

Although the preferred embodiments of the present invention have been described, it will be understood by those skilled in the art that the present invention should not be limited to the described preferred embodiment, but various changes and modifications can be made within the spirit and scope of the present invention as defined by the appended claims.

What is claimed is:

1. A method for securing an elastic band having a meltable material layer to an article, the method comprising the steps of:
extending said article on a workbench;
feeding the elastic band to a positioning device;
positioning the elastic band on a predetermined position of said article in such a way that the meltable material is in contact with said article;
activating the meltable material layer;
pressing the elastic band on said article; and
cutting said article along with an edge of said elastic band.

2. The method of claim 1, further comprising the step of heat-pressing the secured elastic band.

3. The method of claim 1, the step of positioning the elastic band further comprising the steps of:
feeding the elastic band to a roller;
rotating said roller; and
simultaneously with the step of rotating, unwrapping said elastic band on said article.

4. The method of claim 3, the step of rotating the roller further comprising the step of:
moving said apparatus along a line determined by an edge of the article while said roller being in contact with said article.

5. The method of claim 3, the step of rotating the roller further comprising the step of:
moving said article in a positioning direction of the elastic band while said roller being in contact with said article.

6. The method of claim 1, wherein the step of positioning the elastic band is simultaneously with the step of activating the meltable material layer.

7. The method of claim 1, wherein the step of activating the meltable material layer is simultaneously with the step of pressing the elastic band.

8. The method of claim 1, wherein the step of pressing the elastic band is simultaneously with the step of cutting the article.

9. The method of claim 1, wherein the step of positioning the elastic band is simultaneously with the step of activating the meltable material layer, the step of pressing the elastic band, and the step of cutting said article.

10. The method of claim 1, the step of cutting further comprising the step of:
radiating a heat on an external edge of said blade.

11. The method of claim 10, wherein said heat is a laser ray.

12. The method of claim 28, wherein said heat is a hot air.

13. The method of claim 1, the step of activating the meltable material layer further comprising the step of spraying a hot air stream on said meltable material layer of said elastic band when said elastic band is positioned and pressed on said article.

14. The method of claim 1, said meltable material layer comprising a thermoplastic film.

15. The method of claim 1, said meltable material layer comprising a hot melt pressure sensitive film.

16. The method of claim 1, said meltable material layer comprising a polyurethane film.

17. An apparatus for securing an elastic band having a meltable material film on an article, the apparatus comprising:
an axis:
a roller mounted on said axis, said roller being freely rotational with respect to said axis, said roller receiving and positioning the elastic band;
a cutter comprising a blade, said blade being freely rotational with respect to said axis; and
a pipe supplying a hot air toward a portion of the article on wherein said elastic band is positioned.

18. The apparatus of claim 17, further comprising:
a drum mounted on said axis, said drum located between said axis and said roller, said drum having a longitudinal hole, said axis inserted in said longitudinal hole, said axis being able to move along said longitudinal hole; and
a spring mounted within said longitudinal hole, said spring connected to said axis so that said roller keeps a tendency to exert a pressure toward said article.

19. The apparatus of claim 18, further comprising a bearing, said bearing inserted between said roller and said drum, said bearing making said roller freely rotational relative to said axis and said drum.

20. The apparatus of claim 19, said cutter further comprising a heater, said heater heating said blade.

21. The apparatus of claim 20, wherein said heater is electric means for irritating heat on said blade.

22. The apparatus of claim 20, wherein said heater is a laser source.

23. The apparatus of claim 20, wherein said heater is a hot air jet.

24. The apparatus of claim 17, further comprising a workbench on which said article is positioned.

25. The apparatus of claim 24, with said workbench being a belt conveyor.

26. The apparatus of claim 24, with said workbench being movable so that a movement of said workbench rotates said roller when said roller is in contact with said workbench.

27. The apparatus of claim 17, further comprising a heat-press, said heat-press heating and pressing the elastic band positioned on said article.

28. The apparatus of claim 17, with said roller having a guide, said guide guiding said elastic band on said roller.
